(19) United States
(12) Patent Application Publication
(10) Pub. No.: US 2021/0291004 A1
(43) Pub. Date: Sep. 23, 2021

(54) System and Method for Exercise Equipment

(71) Applicant: Anthony Salomone, Odessa, FL (US)

(72) Inventor: Anthony Salomone, Odessa, FL (US)

(21) Appl. No.: 17/327,744

(22) Filed: May 23, 2021

Related U.S. Application Data
(63) Continuation-in-part of application No. 16/362,213, filed on Mar. 22, 2019, now Pat. No. 11,045,687.

(51) Int. Cl. A63B 1/00; B23P 19/04

(52) U.S. Cl. CPC A63B 1/00; A63B 71/0036; B23P 19/04

(57) ABSTRACT

An adaptable exercise system enables the portable and adaptable placement of exercise equipment that can be adjusted to suit the intended exercises to be performed. The system provides a cross bar and legs that can be used in water, sand, gravel, sod or any location. The legs are height adjustable and allow for a variety of configurations and thus exercises.

### BACKGROUND

The present invention relates generally to exercise equipment systems, and more specifically, to tools or systems that facilitate body movement, including for use by people with limited physical mobility. One of the problems commonly associated with common exercise equipment systems are their use-efficiency. For example, the equipment must be fixed in place or secured to other structure limiting their use to that place or an accommodating location.

Further, some systems are difficult for persons doing physical therapy, but who are not buff and well-maintained to begin with. Such exercise system can cause a person's excess body weight to hinder their therapy process, and could cause pulled muscles and other injuries.

Accordingly, although great strides have been made in the area of exercise equipment system, many shortcomings remain.

### BRIEF DESCRIPTION OF THE DRAWINGS

FIGS. 1A and 1B are perspective views of an adaptable exercise system in accordance with a preferred embodiment;

FIGS. 2A, 2B, 2C, and 2D are front views of the legs and height adjustment mechanisms of the system;

FIGS. 3A and 3B are side views of the system of the system in use;

FIG. 4 is a front view of the system in an alternative method of use;

FIG. 5 is a side view of the system in an alternative method of use;

FIG. 6 is a flowchart of a method of use of the system;

FIGS. 7A, 7B, 7C, 7D, 7E, and 7F show details of various fastening mechanisms;

FIGS. 8A and 8B show example shipping containers for the system;

FIGS. 9A and 9B show various aspects of connecting the upper and lower legs;

FIGS. 10A, 10B, 10C, and 10D show non-limiting potential fastening mechanisms for connecting the upper and lower legs;

FIG. 11 shows an example gripping surface;

FIG. 12 shows a potential usage of the system for a physically compromised person; and

FIG. 13 shows an extended version of the system having altered height.

### DETAILED DESCRIPTION OF THE PREFERRED EMBODIMENTS

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another.

Further, the system and method of use will be understood, as to its structure, operation, and manufacture, at least, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings.

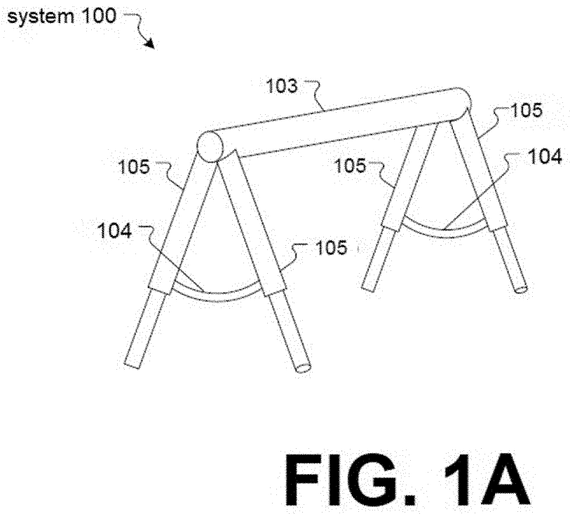

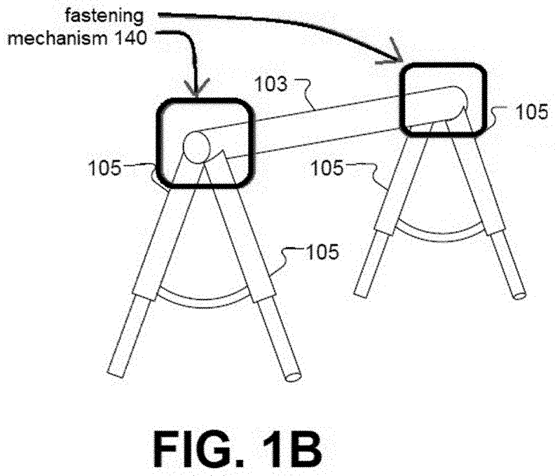

FIGS. 1A and 1B show a perspective view of an adaptable exercise system 100 in accordance with a preferred embodiment. The system 100 overcomes one or more of the above-listed problems commonly associated with conventional exercise equipment systems.

An example system 100 shown in FIGS. 1A and 1B includes a cross bar 103 supported by legs 105. The legs 105 are pivotally attached in pairs at either end of the cross bar 103 using attachment mechanisms 140 (FIG. 1B). The legs 105 are joined as pairs by, for example, a connection resource 104 shown in FIGS. 1A and 1B in the form of bands or lanyards, where the bands 104 are used partly to stabilize the legs 105. In a preferred embodiment, the height of the cross bar 103 is between 4-8 feet from the ground. A preferred width of an operating functioning version of the system 100 might be 54 inches wide, or perhaps 48 inches wide, but numerous other widths will be described herein. Thus, these sizes are given merely as examples and not intended to limit the scope of this disclosure.

FIG. 1B shows the system 100 with fastening mechanisms 140 that are operated by a user or assembler responsible for setting up and securing the system 100. The fastening mechanisms 140 connect the legs 105 to the cross bar 103. The system 100 can be permanently located, but has features intended to make moving or dis-assembling the system 100 easy, practical, and safe. This includes a single user having the ability to set up, take down, and move the system 100 into and out of either water or land environments.

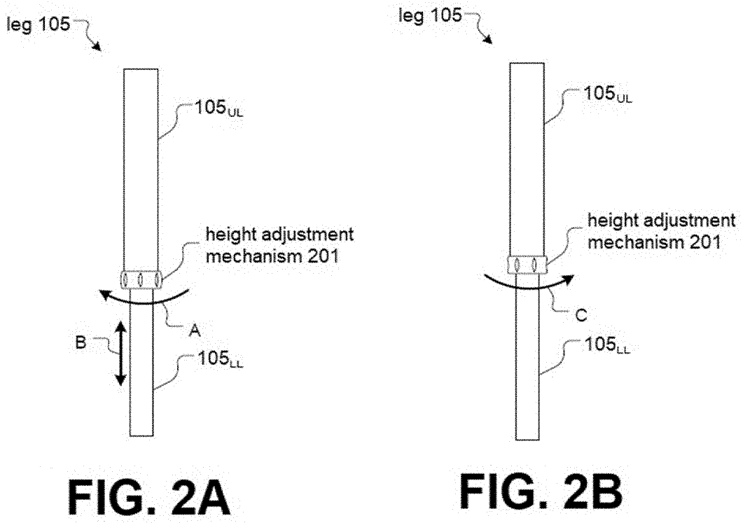

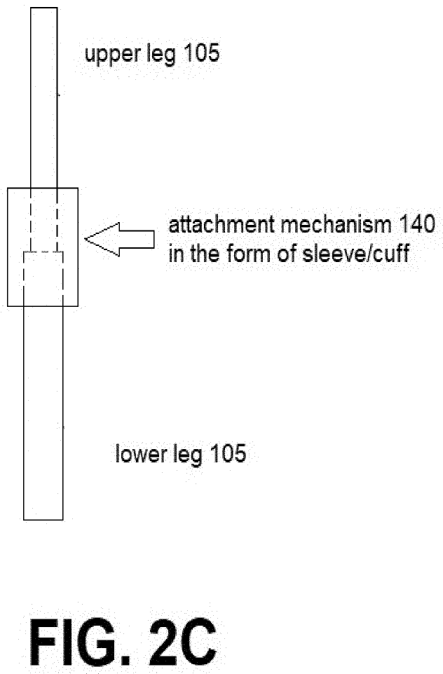

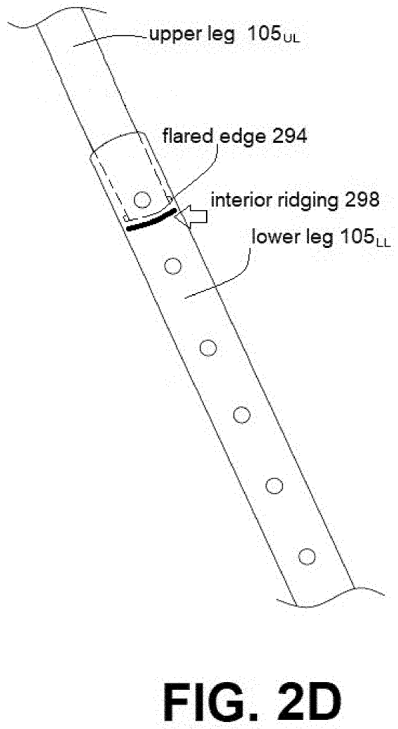

As depicted in FIGS. 2A and 2B, the height of the cross bar 103 is adjustable via height-adjustment mechanisms 201, which in FIGS. 2A and 2B are shown as clamping devices 201_{cd}. However, as will be shown in more detail herein, numerous other height-adjustment mechanisms 201 besides clamping devices 201_{cd} are contemplated herein.

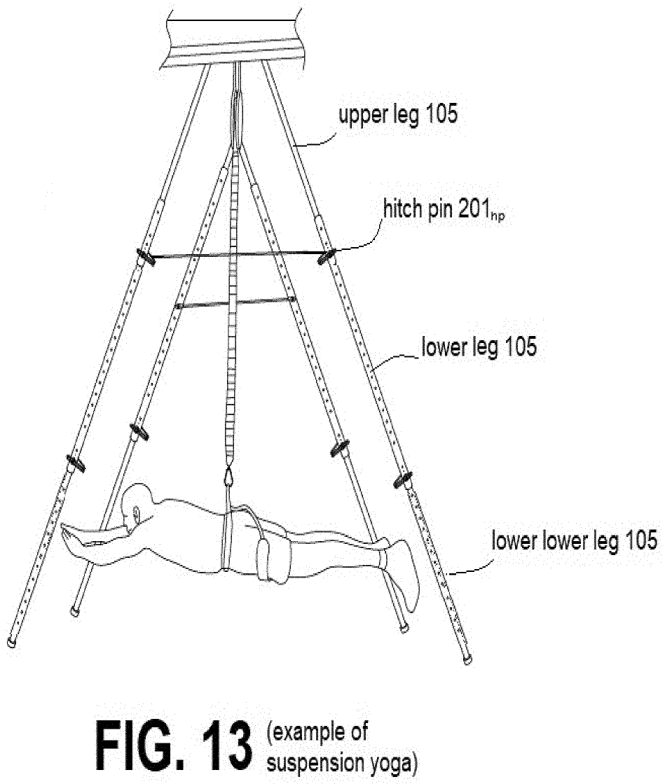

The cross bar 103 could be as small as a half inch in diameter to as much as three inches, depending on a user's size of hands and/or their intended use, e.g. aerial yoga AKA suspension yoga as shown in FIG. 13. The cross bar 103 and legs 105 could be made out of, but not limited to; a steel composite, stainless steel, aluminum, or metal alloy, plastic, or PVC, plastic, or plastic composite such as Kevlar. The cross bar 103 and legs 105 could also be composed of wood, bamboo, or other natural material. Bamboo has several advantages: its usability in a water-based environment, lower weight yet sufficient strength, along with easy and low-cost availability in Asian Pacific, and South American countries.

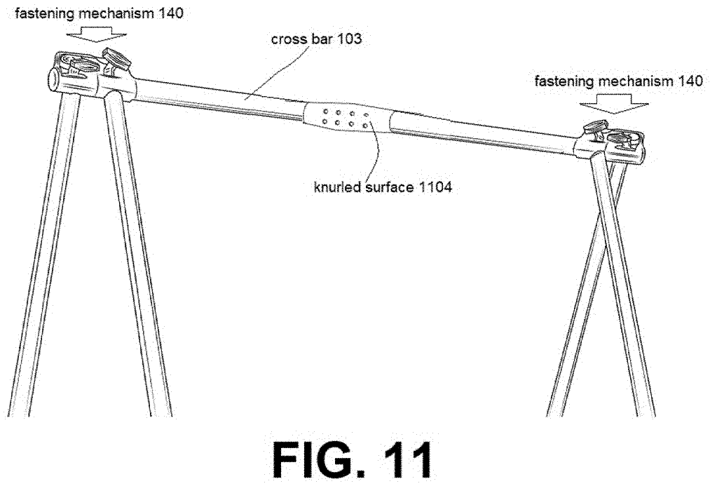

As shown in FIG. 11, an embodiment of the cross bar 103 is fitted with a knurled type of surface 1104 to improve grip for a user. The cross bar 103 could also have a neoprene or some type of rubber sleeve, either as a covering or embedded therein, again for improving grip.

In the specific case of FIGS. 2A and 2B, the clamping devices 201_{cd} are adjustable as depicted by semi-vertical linear motion ‘A’. Meanwhile, the rotation allowing the lower leg 105_{LL} to extend away from the upper leg 105_{UL} is depicted by rotational motion ‘B’. The height adjustment mechanism 201 in the form of the clamping device 201_{cd} is then rotated to secure the lower leg 105_{LL} in place with respect to the upper leg 205, as depicted by rotational motion ‘C’. Each leg 105 is adjustable to accommodate uneven surfaces or to alter the position and height of the cross bar 103.

FIG. 2C shows another embodiment of the height-adjustment mechanism 201, this time a type of cylindrical cuff-shaped height adjustment mechanism 201_{c} having specific features, such as O-rings embedded therein. The cuff-shaped height adjustment mechanism 201 operates by being rotated about the axis of the legs 105.

As shown in various Figures, the lower leg 105_{LL} can have a predetermined amount of adjustment holes which can vary based on proposed lengths, weights, and strengths of material, and even vary depending on intended usage. These holes provide an insertion point to be used by, for example, the hitch pins 201ₕₚ.

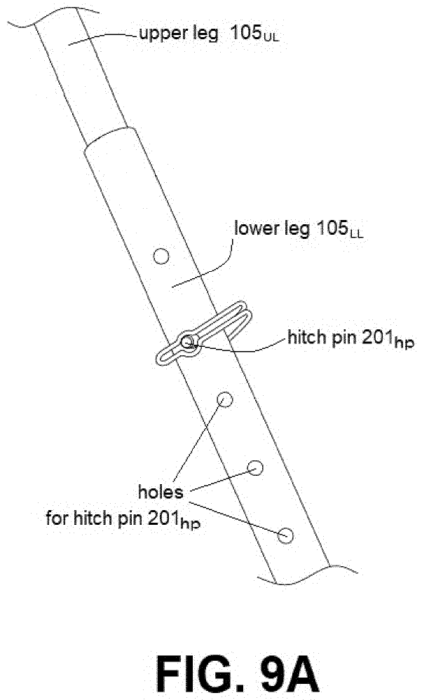

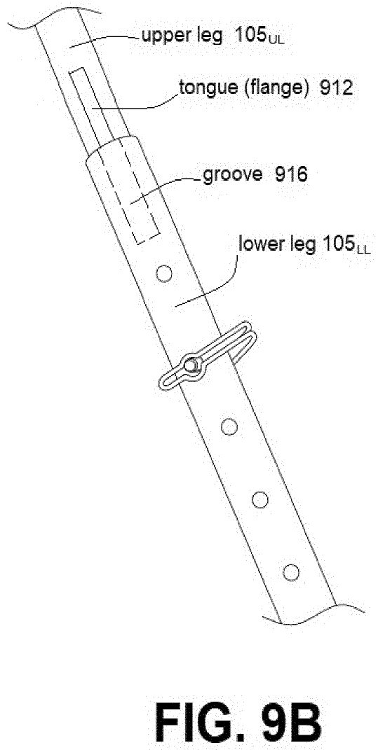

As shown in FIG. 9A, in an embodiment, the height adjustment mechanism 201 can be a stainless steel hitch pin 201ₕₚ. A further embodiment can have a monofilament lanyard 104 (see e.g. FIGS. 1A-1B) located between the two hitch pins 201ₕₚ, although other solutions can be used for the connection-resource 104. Further, the connection-resource 104 need not be connected directly to the hitch-pins 201ₕₚ, and may serve to provide support for the legs 105. The hitch pin 201ₕₚ acts as individual adjustment point for the height of the system but that adjustment point could be a variety of locking mechanisms or different types of pins, and could be made out of different structures, as shown at least within 10A-10D, including but not limited to a friction clamp or a cam lock.

The lower legs 105_{LL} will have holes to accommodate the hitch pins 201ₕₚ. The upper legs 105_{UL} can either be configured with holes such that during use, the hitch pin 201ₕₚ penetrates both the lower and upper legs 105, or where the hitch pin 201ₕₚ penetrates only the lower leg 105_{UL} but then is located underneath the lowest portion of the upper leg 105_{UL}.

During use of the system 100, a side-to-side lateral motion will occur, but the upper leg 105_{UL} will also transfer a consistent and considerable downward force to the lower leg 105_{LL}, specifically at the location of the height adjustment mechanism 201. Thus, it will be advantageous for the system 100 to provide mechanical reinforcement in this area, so that the height adjustment mechanism 201 is not the sole site for bearing this considerable downward force. However, it is also important that whatever solution is implemented does not impede or cause problems for any height adjustment activity, assembly, or dis-assembly being performed by the user.

One way to achieve this is with O-rings, but another way is with reinforcement ridging within a coupling-area of the legs 105, as shown in FIG. 2D. In FIG. 2D, the upper leg 105_{UL} is shown with a flared bottom edge 294, which matches with an interior ridging 298 machined into an interior surface of the lower leg 105_{LL}. In FIG. 2D, various of the portions are exaggerated for clarity.

In an embodiment, the upper leg 105_{UL} is a narrower diameter and thus slides into the lower leg 105_{LL}. However, in doing so, there could also be an insert for being located between the two leg-tubes that keep them separated, and allows for some shear forces and torsion due to lateral movement to be absorbed. Such an insert could be made out of a variety of man-made or natural materials and could be placed in different locations within the various legs 105. It is also possible to include a movable counter-sunk interior into the lower leg 105_{LL}, which maintains adjustability but reduces downward strain on the lower leg 105_{LL}.

One embodiment works as follows: as an assembler slides the legs together, but this step can be rotated improperly thus making lining up the hitch pin 201ₕₚ and a specific hole within the upper leg 105_{UL} difficult. To that end, as shown in FIG. 9B, a groove 916 could be added to the inside of the lower leg 105_{LL}, and a tongue (flange) 912 added to the outside of the upper leg 105_{UL}, thereby keeping the two legs 105 more properly aligned. This feature acts to simplify and fool-proof a process of matching the hitch pin 201ₕₚ with a specific pin hole.

Thus, in all cases, it is necessary that the height-adjustment mechanisms 201 have specific machining and durability properties consonant with achieving both easy installing and removal, but also during use, a pronounced ability to stay together and not give, crack, degrade, bend, and act as a type of temporary but strong joint for where the upper legs connect to the lower legs. As such, the height-adjustment mechanisms 201 must be of a tempered quality that will not, over time, develop “mechanical arthritis”.

To summarize the height adjustment mechanism 201, any of the various height-adjustment mechanisms 201 disclosed herein must be durable, sturdy, and have the ability to withstand variations in force applied thereto, including both vertical and horizontal forces, and also to have the ability to tolerate some limited amount of lateral movement.

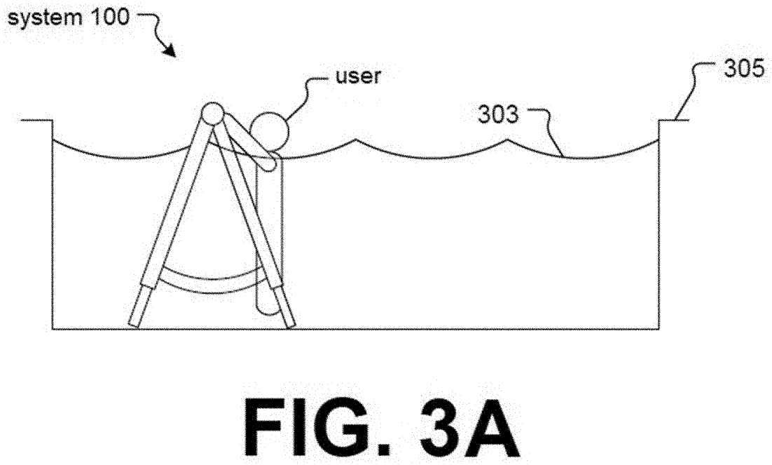

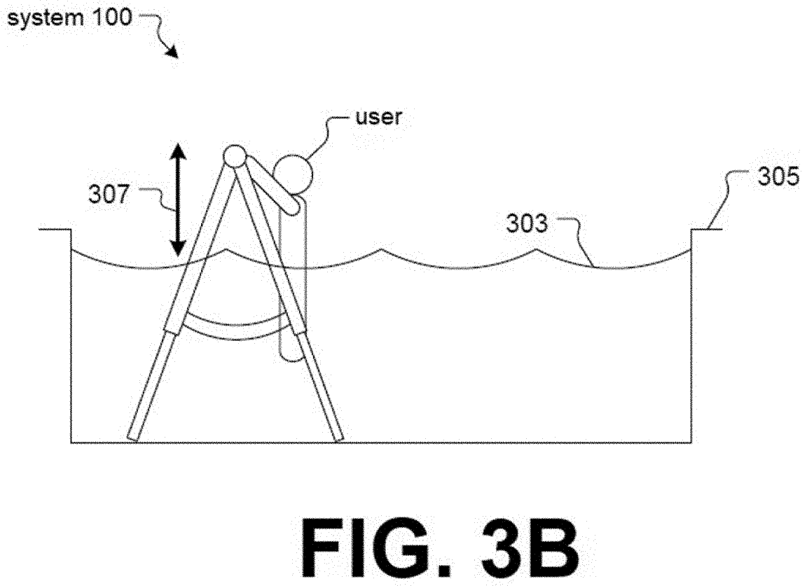

The various legs 105 enable numerous separate configurations of the system 100 and also enable the system 100 to be prepared and moved where it is most useful, including uneven terrain (e.g. campsites, lake bottoms, parks). For example, FIGS. 3A and 3B show an example system 100 located in a pool 305 holding a body of water 303. In an embodiment, the cross bar 103 can be located just above the water 303 level and a user 301 pulls themselves toward the cross bar 103 by holding thereto. When the cross bar is raised distance 307 out of the water 303, a user 301 pulling oneself from the water will then exert a specific type of force to pull themselves from the water 303. The specific upward force needed to pull oneself from the water is less than it would be on land, due to the specific buoyancy gained on the user's body weight by the water, yet the muscles employed in doing so are still getting usage, that is, being exercised.

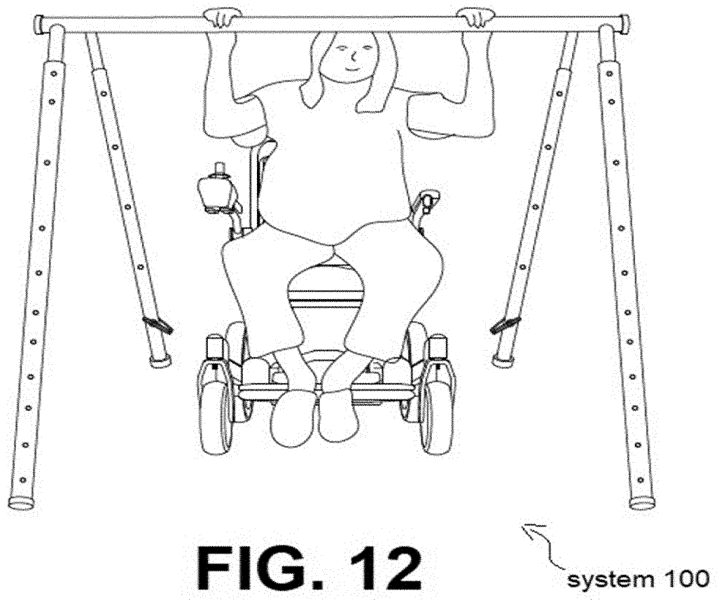

That is, the muscular effort necessary for a person to lift their buoyant body while in the water is less than when they are out of the water. As such, using the system 100, a person with excess body weight or other physical impairment can exercise key muscle groups important to good health without over-straining their joints, and without their body weight working against them. Accordingly, the exercises performed with the system 100 enable the adaptation to users of different strength or skill including persons with compromised physiology including but not limited to paraplegics. An example is shown in FIG. 12. Along with the reduction in effort is a corresponding reduction in strain and joint pain. In this way, the system 100 accommodates users with compromised health and mobility, as well as accommodating fully able-bodied persons.

Either way, whether a person with compromised physiology, or a fully able-bodied person, the system 100 provides a much wider variety of exercises and physical therapy strategies than a mere movable chin-up bar or pull-up bar.

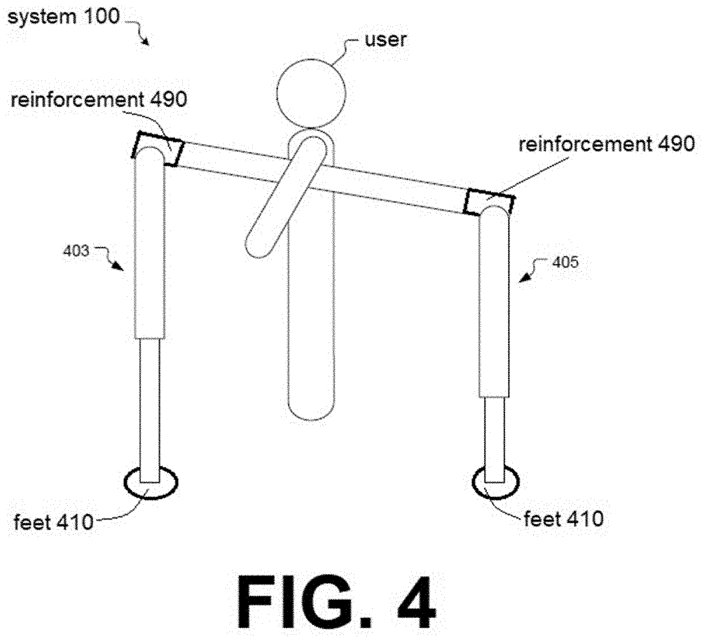

An alternative method of use for the system 100 shown in FIG. 4, where the legs 105 are adjusted to a first height 403 on one side and a second height 405 on another. By so arranging the legs 105, the cross bar 103 is no longer parallel to the ground and enables other movements by the user 301.

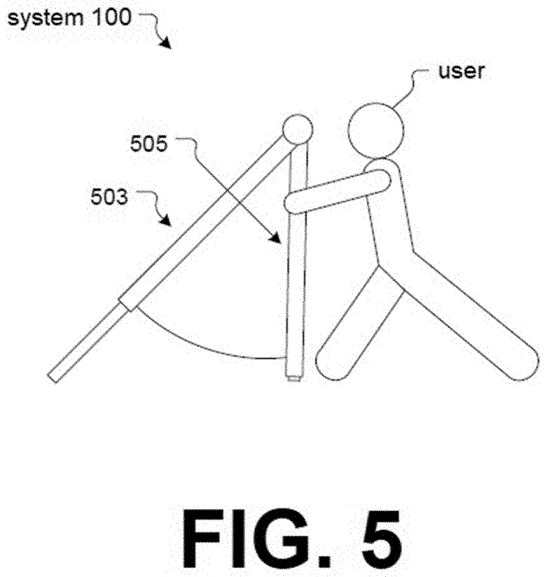

Another use of system 100 is depicted by FIG. 5. In this embodiment, the legs 105 are adjusted so that the foremost legs 105 are perpendicular to the ground by setting them to height 505 and the rear legs 105 to height 503. In this configuration the user 301 is able to push against the foremost legs 105 or the cross bar 103.

While these methods of use have been presented as examples of the use of system 100, other usages are contemplated. These that have been depicted thus far are given only as examples and should not be considered as limiting.

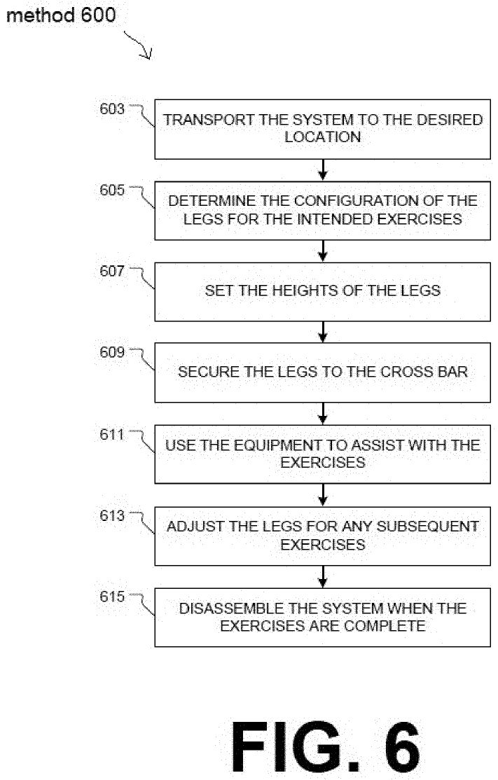

Referring now to FIG. 6, an example method of assembly of system 100 is depicted. The method 601 includes transporting the system to the desired location 603, determining the configuration of the legs for the intended exercises 605, setting the heights of the legs 607, securing the legs to the cross bar 609, using the equipment to assist with exercises 611, adjusting the legs for a subsequent exercise 613 and disassembling the system when the exercises are complete 615.

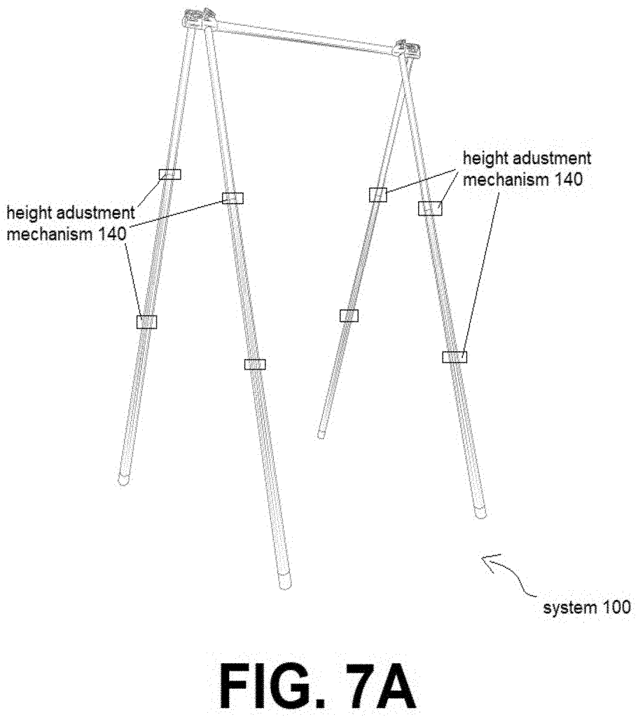

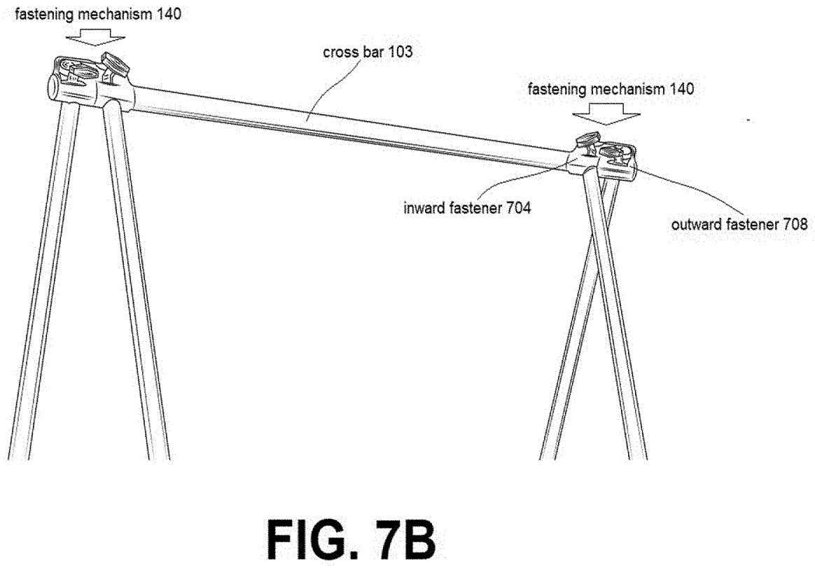

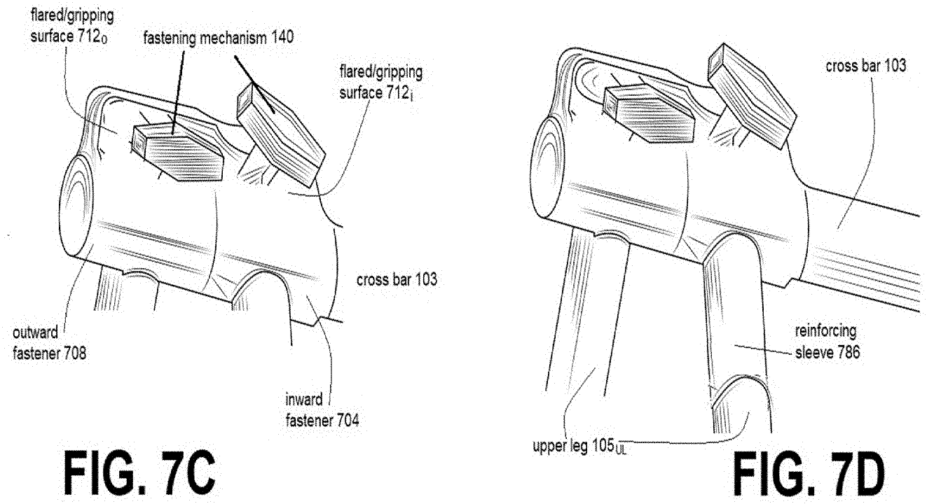

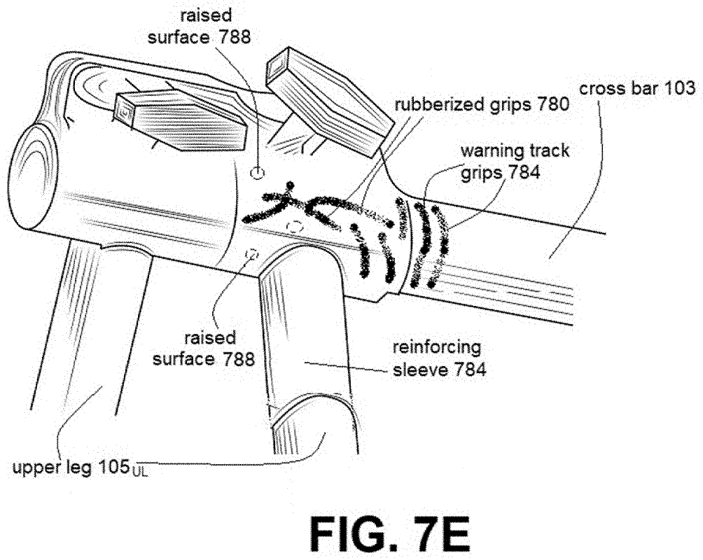

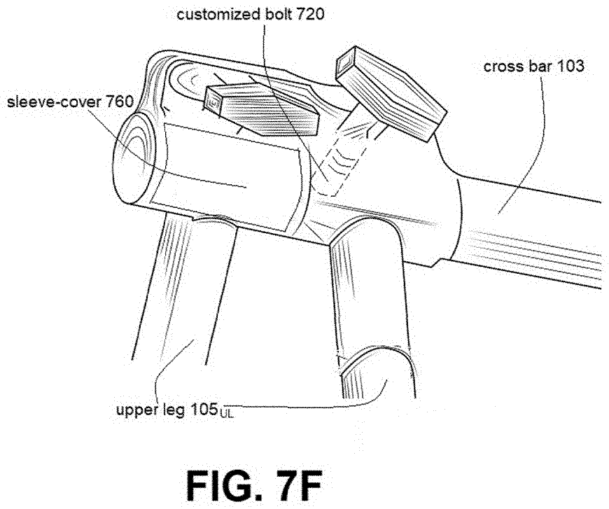

It is a goal of the embodiments herein to make the assembly-process achievable and as foolproof as possible. To the extent possible, the embodiments herein strive to reduce half-assembly and mis-assembly for the system 100. Accordingly, FIGS. 7A, 7B, and 7C show example usability aspects of the fastening mechanisms 140. FIG. 7A shows a way to increase the height of the cross bar 103, where additional legs 105 are added. In an embodiment, a first increase of height can require four more legs 105. After that, additional legs 105 and additional height adjustment mechanisms 140 can be added, as suggested at least within FIG. 7A.

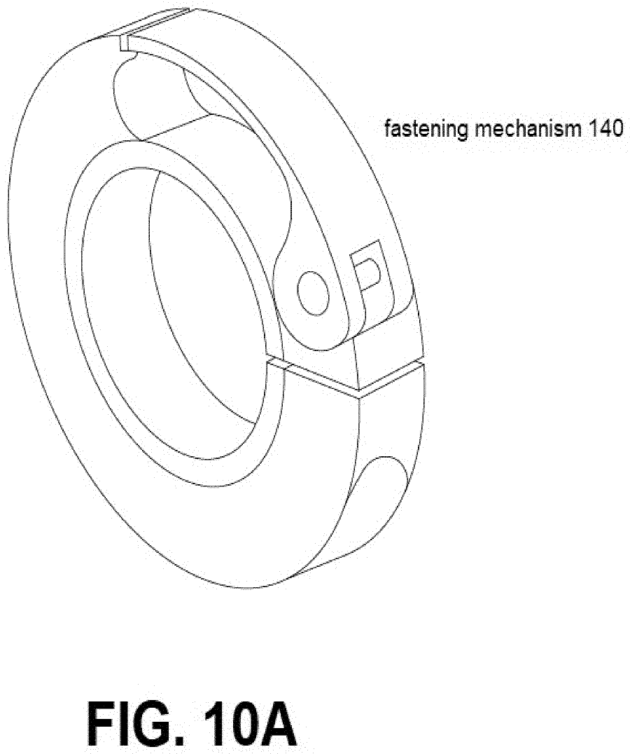

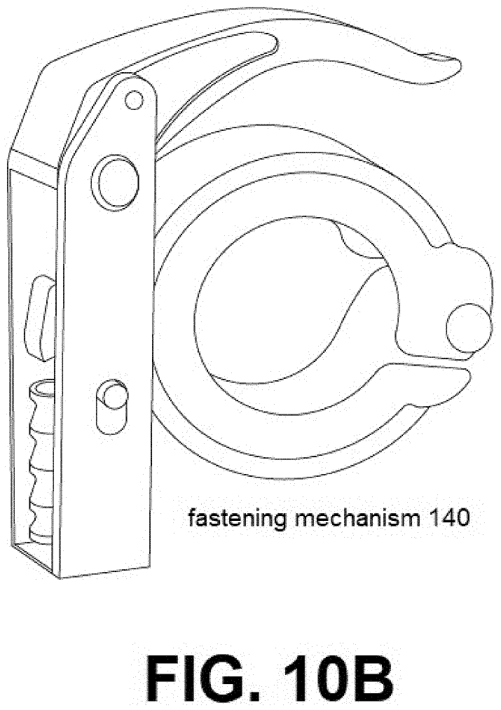

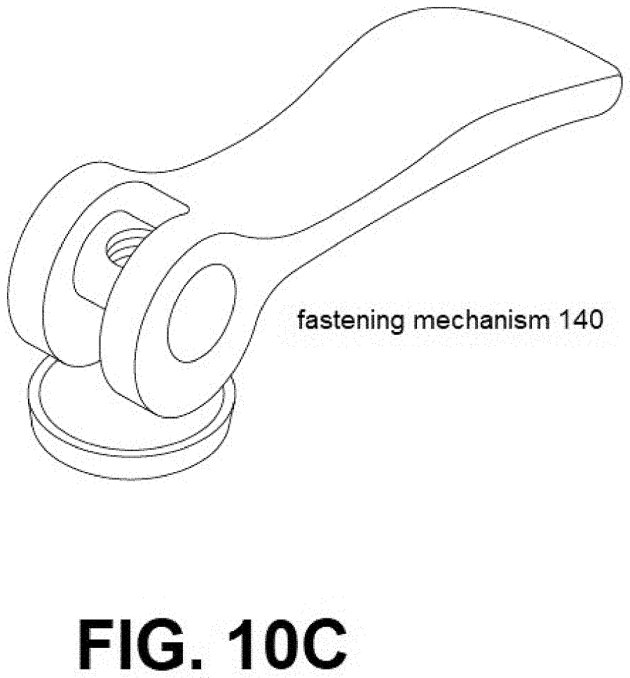

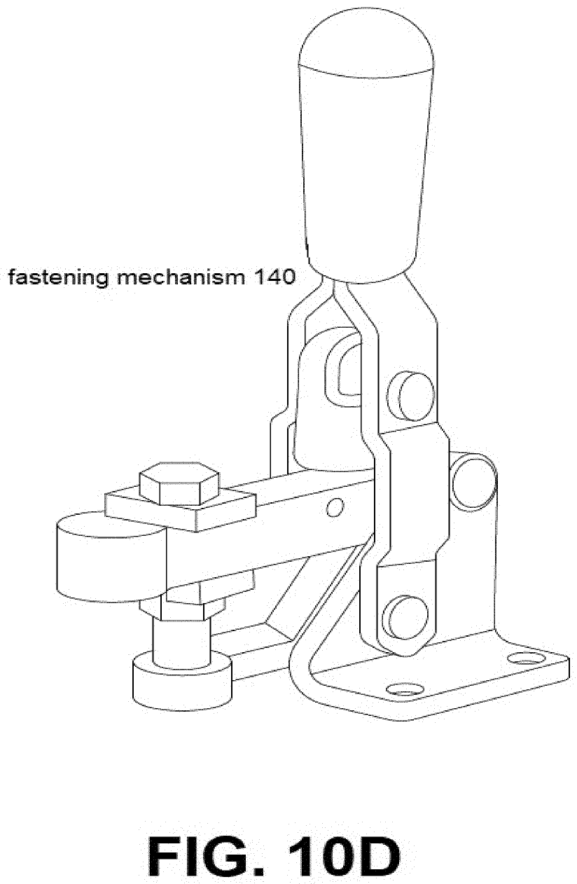

Next, an embodiment of the fastening mechanism 140 can include e.g. a friction clamp with a wing nut and carriage bolt assembly, as shown in for example FIGS. 7B-7E. The inside of the fastening mechanism 140 could be knurled to increase its grip of the cross bar 103, likewise could be made out of a variety of material and sizes. As shown at least within FIG. 7B, one embodiment of a fastening mechanism 140 comprises an inward fastener 704 and an outward fastener 708. In particular, the specific type of fastening mechanisms 716 are shown as threaded finger-tighteners as an example way of assembling/dissembling. However, the embodiments herein should not be considered as limited solely to the finger-tighteners for the fastening mechanisms 140. For example, as shown in FIGS. 10A, 10B, 10C, and 10D, the attachment mechanisms 140 could range from friction clamps to some type of a twist and lock clamp, a pin, a screw on assembly, or a cam lock.

Moving back to FIG. 7C, both the inward and outward fasteners 704 and 708 have flared/gripping surfaces 712ᵢ and 712ₒ respectively. These are for securing and sealing the fasteners 704/708 to the top cross bar 103.

In an embodiment, reinforcing sleeves 786 are attached to a top surface of the upper legs 105_{UL} using e.g. welds, as shown at least within FIG. 7D. However, the reinforcing sleeves 786 could be attached by other means, and could have additional features.

Next, other types of fastening mechanisms can also be used, such as the expanding rubberized grips 780 shown in FIG. 7E, which make the various parts easier to work with and grip, are water-resistant, and are also easier to finger-sense (e.g. provide tactile indications where visibility is constrained or limited). Specifically, the rubberized grips can include but are not limited to “warning track” strips 784 that make it easier for a user to determine by feel, e.g. by finger-feel, that the cross bar 103 is either vary close to or has properly moved into the desired position within the fastening mechanism 140. Further, the fastening mechanism 140 can be fitted with raised surfaces or dots 788 on the interior (thus shown by dashed-line in FIG. 7E) where either the leg 105 or the cross bar 103 is intended to be seated, such that a user can sense the increased resistance of the dots 788 as the various parts are sliding together, and thus again get a tactile non-visual indication of proper fit.

These various features can work together to make the overall system 100 less expensive to manufacture, avoid requiring a tapping of threaded surfaces within the legs 105, and also make the legs 105 less likely to be subject to salt-water erosion, rust, and other decay known to occur in conjunction with water environments.

The above features, and others described herein, are advantageous for preventing the cross bar 103 from falling apart or off during use, that is, seeming to be properly attached but in fact only loosely attached, or improperly attached. A user may not find this out until they attempt to use the system 100 at which time the cross bar 103 falls off while the user's body weight is attached thereto. This condition is prevented within the system 100, due to the various types of fool-proofing or safety-proofing of the fastening mechanisms 140 described herein.

Next, in an embodiment, the fastening mechanisms 140 can be varied according to the specific type of embodiment of the system 100 being sold. Some embodiments will be suitable for being installed permanently, while other embodiments may be designed for frequent movement, frequent installation, and frequent de-installation. That is, there will be varying embodiments depending on length of time the device is expected to be installed. Some versions of the system 100 described herein are not moved, and remain in place relatively permanently, like a child's swingset, which may sit in place for 2 or 3 years. In such a case, the fastening mechanisms 140 may be different than for the other versions of the system 100 which are made to be dis-assembled and transported more often. That is, various different embodiments can be sold, to match up with various different types of end-users and their constraints.

Further additional embodiments exist, some for easy transport in a car and travel environment, for fitting within either checked baggage or fitting under the plane, narrower for single-person use in confined spaces, and\or a lower height, perhaps for people of varying height or needing a different type of usage involving less space.

There also exists a wrap-around aspect, in which a careless assembler is prevented making a half-hearted assembly of a system 100. Specifically, in an embodiment shown in FIG. 7F, a customized bolt 720 within the fastening mechanism 140 must extend all the way through to an opposite side of the cross bar 103, where that customized bolt 720 must mate with a specific nut either embedded within or part of the cross bar 103. FIG. 7F also shows a type of sleeve-cover 760 which matches with the fastening mechanism 140, and can be labeled in e.g. bright day-glow yellow. This sleeve-cover 760 has an elastic tendency to extend across one side of the fastening mechanism 140 to the other, such that even an impaired assembler will know to complete the assembly of the system 100 on both sides of the fastening mechanism 140. Further, in the event the inward/outward fasteners 704/708 may be coming loose, the sleeve-cover 760 may be dislodged out of its position, giving a type of “compromised safety” warning. With its day-glow yellow color, the sleeve-cover 760 being out of position is intended to act to notify\warn the user that the inward/outward fastener 704/708 has worked its way loose or was never proper in the first place. This feature is aimed primarily at the traveling embodiment of the system 100, in which a user frequently assembles and dis-assembles the system 100. However, this feature could also be found advantageous by a user intending to install a system 100 just once and never move it. Nonetheless, no matter what, it is still a good safety practice to check over the system 100 before putting one's body weight thereupon.

Next, the system 100 can be manufactured in various sizes. For example, sometimes, container loads from overseas manufacturer can be more easily arranged when the entire item is not greater than 48 inches long. If so, an embodiment with a cross bar 103 spanning <=48 inches has an advantage of being more space-effective within some types of shipping containers, and thus can be more cost-effective to ship. An even narrower embodiment also exists, for customers having limited space. This narrower embodiment can be set up more easily, but the wider embodiments have the advantage of separating the load-bearing elements to be further apart, thus increasing overall stability of the system 100. An embodiment with a cross bar 103 spanning >, 48 inches also exists, at least because an embodiment that spans a wider ground-area, a wider footprint, may have the effect of distributing the weight and downward forces across a broader area. Further, not all embodiments herein will require overseas manufacture.

Next, regarding materials, the legs 105 can be made using a predetermined grade of steel or other alloy. A graphite/aluminum composite can also be used, which has the advantage of lighter weight, lower cost, higher availability, and uses materials that are less likely to be politically sensitive (e.g. steel, in light of potential steel tariffs).

### Shipping

The length and weight of the system 100 when un-assembled, can cause unusual stress and torque on the cardboard boxes typically used for shipping. This can result in crushing and distortion of the cardboard, and to the point that the various portions therein can be chipped or scuffed.

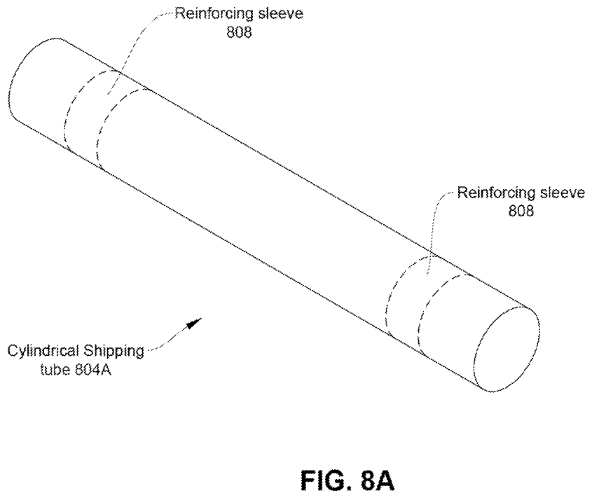

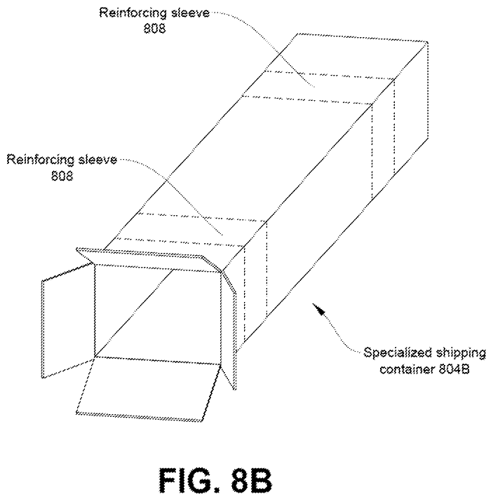

To address this, FIG. 8A shows a specific type of customized reinforced shipping tube container 804A to have a variety of reinforcements and bracing therein depending on the specific type of system 100 being shipped. The cylindrical shipping tube 804A can have various lengths. Meanwhile, FIG. 8B shows a customized box/package mechanism 804B that is not a stock “one size fits all” type of box but instead contoured to the specific dimensions, weights, and changing centers of gravity associated with the system 100.

Specifically, FIGS. 8A-8B shows protective sleeves 808 at strategic places in the containers 804A\804B. There are two key mechanical principles at place here. A first mechanical principle is that the system 100 in a dis-assembled state has many long heavy elements, and thus is best shipped in a long, elongated box or container such as container 804A\804B. It is well known that shippers, e.g. Fed Ex, UPS, other, that handling long heavy boxes is more difficult, more subject to mis-loading and mis-handling, than more conventional cubical boxes.

A second mechanical principle is that the ends of the various bars 103 and legs 105 of the system 100 are, in many ways “where the action is”, that is the mechanical action. As such, these elements must not be dinged, dented, compromised, or altered by troubles and mis-handling in the shipping process. For example, after assembly, the cross bar 103 will be somewhat protected from impact by the attachment mechanisms 140. However, during shipping, no such protection exists as the attachment mechanisms 140 are not connected to anything during shipping, thus the ends of the cross bar 103 may be more vulnerable at this time. A third mechanical principle is that long containers (tubes or boxes) that are also heavy, often may have an unusual center of gravity, in which someone may lift the container with only their hands, and then quickly drop it or lose control of it because they lifted the wrong end, and did not realize where the center of gravity is located. This can result in damage to the contents of the tube or box (e.g. container 804).

For example, if the ends of the cross bar 103 are dented or cracked, the fasteners 704/708 may have trouble holding their grip. The mechanical strength of the fasteners 704/708, and their ability to grip, is based on a uniform cylindrical surface of the cross bar 103 being located therewithin. If the cross bar 103 has alterations to it, the fasteners 704/708 being semi-cylindrical themselves, may not be able to properly enclose and properly seal around the cylindrical shape of the cross bar 103. Consequently, the cross bar 103 can be manufactured with cylindrical reinforcements 490 at both ends, as shown in FIG. 4.

To address this, the various versions of the system 100 can be packed to have the center of gravity of the actual packaged unit to be near to the center as reasonably possible, using e.g. low cost spacers and position-holders, and specialized proprietary low-cost low-weight high-strength bracing therein.

The various legs 105 and cross bar 103 could be fitted out with a variety of “skins” (surfaces either part of or attached thereto) to change the functionality, appearance, or color of the system 100. Within the various Figures herein, all tubing of the system 100 is shown as round but could be different shapes including but not limited to; triangular, square, pentagonal, heptagonal, octagonal etc.

In an embodiment within the system 100, the feet are easily interchangeable and could be made of a variety of materials to adhere to a surface or to protect a surface, such as heavy rubber feet 410 (shown in FIG. 4). For example, the feet 410 could include a plastic disc to disburse and distribute the weight and downward forces of each lower leg 105_{LL} when located in a pool with a plastic liner, where it is desired to not tear that plastic liner.

As shown in FIG. 13, any extension legs 105 work with the hitch pin holes already existing on the lower legs 105_{LL} (see e.g. FIGS. 9A-9B) and yields varying heights e.g. as shown in FIG. 13 and can have a variety of types of feet underneath the legs 105, for example the round feet 410 shown in FIG. 4. This attachment allows for use as such as aerial yoga (suspension yoga), bungee, and other uses that require the participant to be elevated higher off the ground.

Next, a mechanism for carrying and transporting the embodiments herein could include a canvas carry bag. However, the system could be a type of box, could have a zipper, wheels, could be made of plastic or other material, and/or could have a cart format.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A method of manufacturing an exercise system, comprising:
configuring four or more cylindrical upper legs to have a first diameter and be connectable to a cross bar;
configuring four cylindrical lower legs to have a second diameter larger than the first diameter, such that the upper legs can be inserted into the lower legs in a slidably adjustable context;
configuring the four cylindrical lower legs to have a first series of collinear holes at a first edge;
configuring the four cylindrical lower legs to have a second series of collinear holes at a second edge exactly 180 degrees opposite the first edge on a leg, and at the same relative height on the body of the leg, such that the first series of holes corresponding with the second series of holes in every way except being 180 degrees apart on the leg;
configuring the four cylindrical lower legs such that the first series of holes and the second series of holes corresponding with each other and being penetrable by a hitch pin, such that one hitch pin can penetrate any particular set of holes in the series; and
configuring a plurality of attachment mechanisms to attach to the cross bar and secure the cross bar to the four upper legs.

2. The method of claim 1, further comprising:
configuring the lower legs and the upper legs to result in a user-adjustable height of the crossbar.
